(19) United States
(12) Patent Application Publication
(10) Pub. No.: US 2014/0181929 A1
(43) Pub. Date: Jun. 26, 2014

(54) METHOD AND APPARATUS FOR USER AUTHENTICATION

(71) Applicant: EMC Corporation, Hopkinton, MA (US)

(72) Inventors: Yingyan Zheng, Shanghai (CN); Zine Zheng He, Shanghai (CN)

(73) Assignee: EMC Corporation, Hopkinton, MA (US)

(21) Appl. No.: 14/132,715

(22) Filed: Dec. 18, 2013

(30) Foreign Application Priority Data
Dec. 20, 2012 (CN) CN201210595746.2

(51) Int. Cl. G06F 21/31

(52) U.S. Cl. CPC G06F 21/31
USPC 726/6; 726/5

(57) ABSTRACT

The disclosure generally relates to methods and apparatuses for user authentication. According to embodiments of the present invention, authentication-related information may be encoded in an image such as a QR code. By communicating and decoding such image information and other authentication information between one or more devices of the user and an authentication server, the authentication server may perform an effective authentication to the user and his/her device. In the meantime, it is possible to avoid the risk of invalid authentication due to the disclosure of the password. Embodiments of the present invention may be used in combination with the existing static password and/or dynamic password authentication and thus they have a good compatibility.

### TECHNICAL FIELD

Embodiments of the present invention generally relate to network security, and more specifically, to a method and apparatus for user authentication.

### TECHNICAL BACKGROUND

With developments of network technologies, it is necessary to authenticate a user in many applications and scenarios, i.e., verifying whether the user's identity is legal for a particular service, data and/or network domain. As an example, the virtual private network VPN is a common network technology, which allows a user to remotely access and use an internal private network of an organization or institution through a public network (for example, Internet). In order to prevent an illegal user from hacking into the internal private network, it is required to perform identity authentication to the user before establishing a VPN connection.

At present, common identity authentication manners may be substantially divided into the following two classes. The first class of identity authentications are based on a username and a static password, where the password associated with the user is stored in an authentication server and the user can only pass the identity authentication by inputting a valid username and a matching password. However, the username and password might be lost or stolen by a malicious third party by means of virus program, Trojan program, etc. In this case, user authentication will lose its validity.

Another class of known identity authentication solutions are based on a dynamic password. In the authentication process, the user needs to input the username and a password that dynamically varies with time, i.e., a dynamic password. The dynamic password is for example generated by the authentication server and sent to a user device at a predetermined time interval. Or the authentication server and the user device may synchronously generate this dynamic password, where the passwords generated by both parties are identical to a given user in a given period of time. The user device is always a portable device, for example, assigned to the user by the provider of the authentication service. Moreover, the dynamic password may also be used in cooperation with the traditional static password. At present, such dynamic password has been widely applied in many fields such as VPN, finance, and banking services.

However, in a dynamic password-based user authentication, the user has to carry a dedicated portable device; otherwise, the authentication cannot be implemented, which apparently brings convenience to the user. In an improved dynamic password solution, a dedicated program may be installed on the user's mobile phone or PDA for receiving a dynamic password, without the need of carrying a dedicated portable device. However, the user still has to input the dynamic password upon authentication, and the operation per se is error-prone, especially in a mobile environment. Besides, like the username and static password, the dynamic password still has a risk of being illegally obtained by a malicious third party.

### SUMMARY OF INVENTION

In view of the above and other problems and defects in the field, the present invention provides a more effective user authentication solution.

According to a first aspect of the present invention, there is provided a method for user authentication. The method comprises: reading an image from a device associated with a user, the image being generated at an authentication server in response to an authentication request received from the device and being sent to the device; decoding from the image property information of the device and first authentication information generated at the authentication server; obtaining second authentication information associated with the user; and sending the first authentication information and the second authentication information to the authentication server for authentication of the user.

According to a second aspect of the present invention, there is provided a method for user authentication. The method comprises: receiving at an authentication server an authentication request from a device associated with a user, the authentication request at least comprising property information of the device; generating first authentication information for authenticating the user in response to the authentication request; encoding the property information and the first authentication information into an image for transmission to the device; and receiving the first authentication information as decoded from the image and second authentication information associated with the user for the authentication.

According to a third aspect of the present invention, there is provided an apparatus for user authentication. The apparatus comprises: a reading unit configured to read an image from a device associated with a user, the image being generated at an authentication server in response to an authentication request received from the device and being sent to the device; a decoding unit configured to decode from the image property information of the device and first authentication information generated at the authentication server; an obtaining unit configured to obtain second authentication information associated with the user; and a sending unit configured to send the first and second authentication information to the authentication server for authentication of the user.

According to a fourth aspect of the present invention, there is provided an apparatus for user authentication. The apparatus comprises: a first receiving unit configured to receive at an authentication server an authentication request from a device associated with a user, the authentication request at least comprising property information of the device; an authentication information generating unit configured to generate first authentication information for authenticating the user in response to the authentication request; an encoding unit configured to encode the property information and the first authentication information into an image for transmission to the device; and a second receiving unit configured to receive the first authentication information as decoded from the image and second authentication information associated with the user for the authentication.

It would be appreciated through the following description that according to embodiments of the present invention, the authentication-related information may be encoded in an image like a QR code. Through communicating and decoding such image information and other authentication information between one or more devices of a user and an authentication server, the authentication server may perform an effective authentication to the device used by the user and the user himself; meanwhile, the authentication invalidity risk due to password leakage in the prior art is also prevented. Embodiments of the present invention may be used in cooperation with the existing static password and/or dynamic password authentication, and therefore has a good compatibility.

### BRIEF DESCRIPTION OF THE DRAWINGS

Through reading the following detailed description with reference to the accompanying drawings, the above and other objectives, features and advantages of embodiments of the present invention will become more comprehensible. In the accompanying drawings, several embodiments of the present invention are illustrated in an exemplary, instead of limiting, manner, wherein:

FIG. 1 illustrates a block diagram of a system according to embodiments of the present invention;

FIG. 2 illustrates a block diagram of another system according to embodiments of the present invention;

FIG. 3 illustrates a flowchart of a method for authenticating a user identity according to embodiments of the present invention;

FIG. 4 illustrates a flowchart of a method for authenticating a user identity according to embodiments of the present invention;

FIG. 5 illustrates a block diagram of an apparatus for authenticating a user identity according to embodiments of the present invention;

FIG. 6 illustrates a block diagram of an apparatus for authenticating a user identity according to embodiments of the present invention; and

FIG. 7 illustrates a block diagram of a computer system available for implementing embodiments of the present invention.

In respective figures, same or corresponding numbers represent the same or corresponding parts.

### DETAILED DESCRIPTION OF EMBODIMENTS

Hereinafter, the principle and spirit of the present invention will be described with reference to the several exemplary embodiments as illustrated in the figures. These embodiments are merely given to enable those skilled in the art to better understand and further implement the present invention, without limiting the scope of the present invention in any sense.

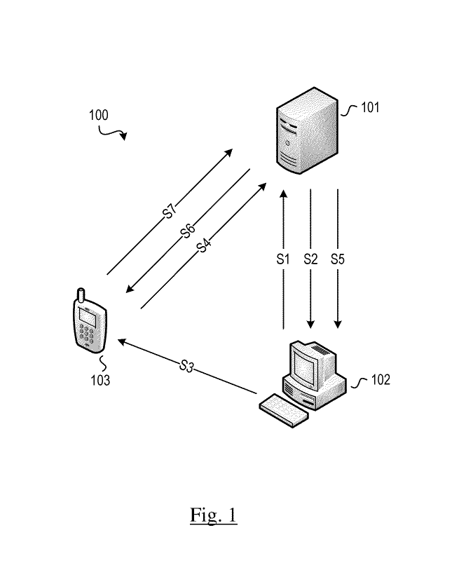

Reference is first made to FIG. 1, which illustrates a block diagram of a system 100 according to embodiments of the present invention. As illustrated in the figure, the exemplary system 100 comprises: an authentication server 101, a first device 102 associated with a user, and a second device 102 associated with the user. The authentication server 101 is a server for authenticating the identity of the user, which, for example, is owned and maintained by a provider of the authentication service. The first device 102 and the second device 103 may be any currently known or future developed user devices, including, but not limited to, a personal computer, a laptop, a tablet computer, a mobile phone, a personal digital assistant (PDA), a pager, etc. In particular, according to some embodiments of the present invention, the second device 102 may be a portable device that can be carried by the user, for example, a mobile phone of the user.

The authentication server 101 and the first device 102, as well as the authentication server 101 and the second device 103, may communicate with each other via a network. The network may comprise a wired network, a wireless network, or a combination thereof, including, but not limited to, a cellular telephony network, an Internet, an Ethernet, a wireless location area network based on IEEE 802.11, 802.16, 802.20, and etc., and/or a world interoperability for microwave access (WiMax) network, etc. Alternatively or additionally, the authentication server 101 and the first device 102 and/or the third device 103 may also communicate with each other via a device for interconnecting and communicating between devices, such as a bus.

In operation, the user may send an authentication request (S1) to the authentication server 101, the authentication request indicates to the authentication server that a user of the first device 102 requests the authentication server 102 to perform identity authentication to the user itself. As an example, the objective of identity authentication may be establishing an authorized connection between the authentication server 101 and the first device 102, for example, a VPN connection.

According to embodiments of the present invention, the authentication request at least comprises property information of the first device and any other required information. The term “property information” used here refers to any indication that can individually or through mutual combination uniquely identify the first device 102, for example, including, but not limited to one or more of the following: a central processing unit (CPU) code of the first device, a serial number of the operating system of the first device, the computer name of the first device, the MAC (media access control) address of the network adaptor of the first device, and etc.

At the authentication server 101, in response to receiving an authentication request from the first user device 102, authentication information available for subsequent authentication process may be generated, which is called “first authentication information.” According to some embodiments of the present invention, the first authentication information for example may comprise an identity (ID) of a network session between the authentication server 101 and the first user device 102. Alternatively or additionally, the first authentication information may include a random code generated at the authentication server. For example, this random code may be generated utilizing the currently known or future developed pseudo-random number algorithm. The first authentication information may further include any alternative or additional information, for example, a random key, property information of the authentication server, etc. The scope of the present invention is not limited in this aspect.

Next, the property information of the first device as received from the first device 102 and the first authentication information as generated at the authentication server will be encoded into an image at the authentication server 101. According to some embodiments of the present invention, for example, a QR code may be generated to carry the encoding information. As already known in the art, “QR code” is a technology of recording data information on a 2D plane in the manner of image using a particular geometric drawing. Given to-be-encoded information, the information may be encoded into a QR code using any currently known or future developed QR code generating algorithm and/or tool. The scope of the present invention is not limited in this aspect.

Besides the QR code, any other appropriate type of image may be generated to encode the property information of the first device 102 and the first authentication information. For example, in the technical field of information hiding, various manners may be employed to encode the information into an image, for example, encoding a binary string representing the information as color information into an image, or inserting it into any pre-determined location, for example, a reserved bit or a redundant bit. Various kinds of technologies encoding information into an image or a figure can be used in combination with embodiments of the present invention, and the scope of the present invention is not limited thereto. In fact, in addition to image, various multimedia information such as audio and video may also be utilized as a medium to encode the property information and the first authentication information, and all of such variations fall within the scope of the present invention.

Next, the image encoded with the property information of the first device 102 and the first authentication information is sent from the authentication server 101 to the first user device 102 (S2). At this point, the user may use the second user device 103 to read the image from the first user device 102 (S3). According to some embodiments of the present invention, the first device 102 for example may forward the image to the second device 103 via various kinds of communication means such as Bluetooth, infrared, network, etc. Alternatively or additionally, an image scanning/reading/capturing device equipped on the second device 103 may also be used to directly scan/read the image from the screen of the first device 102. In other words, in this case, it is possible to cause the image encoded with the property information and the first authentication information to be displayed on the display of the first device 102. The second device 103 obtains the image through image capturing. Any technical means for communicating images between the first device 102 and the second device 103 may be used in combination with embodiments of the present invention, as long as it can guarantee the security of image communication (i.e., guaranteeing that the image will not be illegally obtained or tampered by a third party during the communication process). The scope of the present invention is not limited thereto.

Then, the image may be decoded at the second device 103 so as to extract the property information of the first device 101 and the first authentication information generated as the authentication server 101. It would be appreciated that as long as the second device 103 has the knowledge of how to encode the information into the image, it may correspondingly decode the corresponding information. Such knowledge, for example, was provided from the authentication server 101 to the second device 103 in advance. Otherwise, if it has no encoding knowledge of the authentication server 101, it would be impossible to correctly decode the information in the image. In this way, the security of user authentication can be enhanced.

Next, authentication information associated with the user may be obtained at the second device 103, which is called “second authentication information” here. According to some embodiments of the present invention, the second authentication information, for example, may comprise a static password received from the user. Alternatively or additionally, the second authentication information may also comprise a dynamic password. Specifically, a dynamic password may be generated in a manner of synchronizing with the authentication server 102, comprising receiving the dynamic password from the server 101. In other words, for the same user, at the same time, the dynamic password maintains consistent between the authentication server 101 and the second user device 103. The dynamic password may vary with a predetermined time cycle, f or example, varying once every minute, which is already known in the art and will not be detailed here. Besides, the second authentication information may also comprise any alternative or additional information, for example, an image verification code, a user's biological authentication information (for example, fingerprint, palm print, iris information), etc. The scope of the present information is not limited in this aspect.

Specifically, according to some embodiments of the present invention, the second authentication information may be automatically obtained in response to successful decoding of the image. Alternatively, the second authentication information may also be obtained in response to the user's confirmation of the property information of the first device 102. Specifically, after decoding the image, the decoded property information of the first device 102 is caused to be displayed to the user through the second device 103. The user may confirm whether the first device 102 currently performing the authentication process is legal. In this way, it is possible to effectively prevent other user from illegally or unauthorized embezzling the user's device to perform authentication.

Afterwards, the first authentication information as decoded from the image and the second authentication information as obtained at the second device 103 is sent from the second device 103 to the authentication server 101 (S4). For example, in some embodiments, the first authentication information and the second authentication information may be packaged, and the package is transmitted via the network connection between the second device 103 and the authentication server 101.

After receiving the first authentication information and the second authentication from the second user device 103, the authentication server may utilize such information to authenticate the identity of the user. For example, in some embodiments, it may be first confirmed at the authentication server 101 whether the first authentication information matches the first authentication information as previously generated at the authentication server. For example, if the first authentication information comprises a session ID between the authentication server 101 and the first device 102, then the authentication server 101 may verify whether the received ID corresponds to the actual session ID between the authentication server 101 and the first device 102. For another example, if the first authentication information comprises a random code, then the authentication server 101 may verify whether the random code is identical to the previously generated random code. If the first authentication information matches, it indicates that the first device 102 correctly receives the image sent from the authentication server 101, the second device 103 correctly decodes the encoded information in the image, and possibly the user has configured the validity of the first device 102. In this way, the security of the authentication may be guaranteed from various aspects.

Next, the authentication server 101 may verify the user's second authentication information, for example, comparing the static password with the password stored for the user, and/or verifying whether the dynamic password as generated at the authentication server 101 is consistent with the dynamic password as received from the second device 103. If the second authentication information also passes the verification, then the authentication to the user is successful.

In some embodiments, in response to the user's authentication being successful, the authentication server 101 may issue an authorization (S5) to the first device 102 to establish a trustworthy connection, for example, VPN authorized connection, etc.

Optionally, after the authorized connection with the first device 102 is established, the authentication server 101 may send a message (S6) to the user's second device 103 to indicate that the authentication server 101 has granted an authorization to the first device 102. The authentication server 101 may also transmit the status of the authorized connection (for example, VPN connection) to the second device 103. Optionally, the user may send a message (S7) to the authentication server 101 via the second device 102 to instruct to close or disconnect the authorized connection between the authentication server 101 and the first device 102, which grants the user more flexibility and convenience to control the authorized connection.

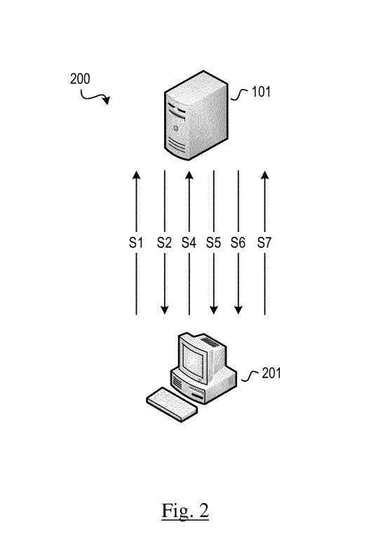

It should be noted that what was described above with reference to FIG. 1 is merely a feasible embodiment of the present invention, not intended to limit the scope of the present invention. For example, in the embodiment as described with reference to FIG. 1, the user uses two devices (i.e., the first device 102, and the second device 103 which may be a portable device) to implement the identity authentication. Alternatively, the user may also merely use one device to implement the above operations. Such embodiment is illustrated in FIG. 2.

In the embodiment as illustrated in FIG. 2, there is only one user device 201. In other words, in terms of function, the user device 201 in FIG. 2 corresponds to the first device 102 and the second device 103 as illustrated in FIG. 1. In particular, when the user device 201 receives the image from the authentication server 101 (S2), it is not required to communicate the image to another device, but performs decoding the image, obtaining the second authentication information, sending the first and second authentication information (S4) and all subsequent operations by itself.

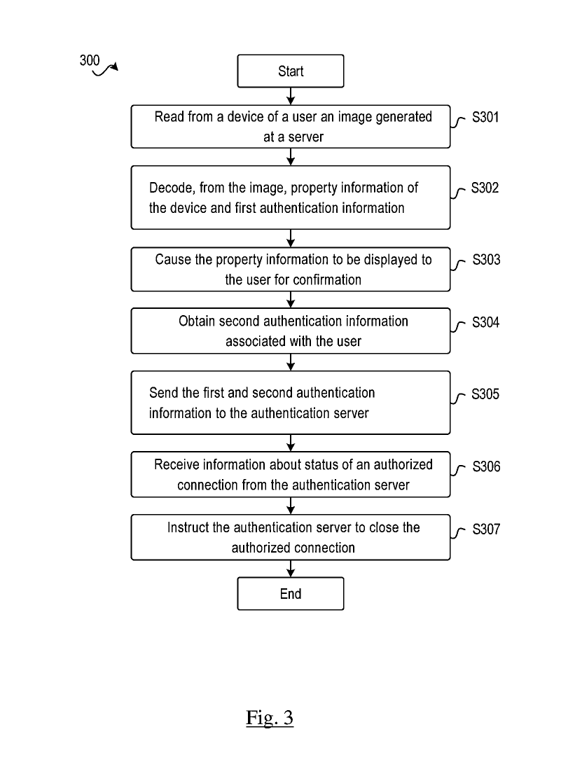

Now, refer to FIG. 3, FIG. 3 illustrates a flowchart of a method for user authentication according to the exemplary embodiments of the present invention. It would be appreciated that in the embodiment as shown in FIG. 1, the method 300 may be executed at the second device 103; in the embodiment as shown in FIG. 2, the method 300 may be executed at the user device 201.

After the method 300 starts, in step S301, image is read from a device (102, 201) associated with a user. As mentioned above, the image is generated at an authentication server (101) in response to an authentication request received from the device and is sent to the device from the authentication server. According to embodiments of the present invention, the image, for example, may be a QR code and encoded with the property information of the first device and the first authentication information as generated as the authentication server. According to some embodiments, the first authentication information as generated at the authentication server for example may include at least one of: a session identifier between the authentication server and the device, and a random code generated at the authentication server.

Next, in step S302, the property information of the device (for example, machine name, MAC address, CPU code, OS serial number, etc.) and the first authentication information generated at the authentication server are decoded from the image. Optionally, in step S303, the decoded device property information is caused to be displayed to the user for the user's confirmation. If the user confirms the property information, then second authentication information is obtained in step S304. The second authentication for example may comprise a static password received from the user and/or a dynamic password generated in synchronization with the authentication server. It should be noted that the step S303 is optional. As above mentioned, in some embodiments, the second authentication information can be directly obtained after decoding the image, without the user confirming the property information.

Then, in step S305, the first authentication information and the second authentication information are sent to the authentication server. The first authentication information and the second authentication information will be used to verify the user's identity at the authentication server. Once the verification of the user is successful, in some embodiments, the authentication server may establish an authorization connection such as VPN connection between itself and the user's device (102, 201).

The method 300 proceeds to an optional step S306, where the status of the established authorized connection may be received from the authentication server. Next, in the optional step S307, the user may use its device (103, 201) to send a command to the authentication server to instruct the authentication server to close the authorized connection. It should be noted that, the user may determine whether to instruct the authentication server to close the authorized connection in step S307 at least partially based on the connection status received in step S306.

The method 300 ends after step S307.

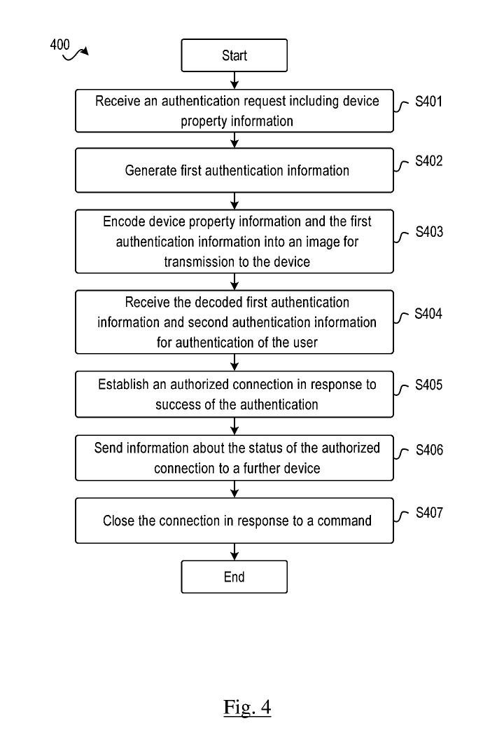

Now, referring to FIG. 4, it shows an embodiment of a method 400 for user authentication according to the exemplary embodiments of the present invention. It would be appreciated that the method 400 may be executed at an authentication server (101).

After the method 400 starts, in step S401, an authentication request is received at the authentication server (101) from a device (102, 201) associated with a user. According to embodiments of the present invention, the authentication request at least comprises property information of the device. The example of the device property information has been described above, which will not be detailed here.

Next, in step S402, first authentication information is generated at the authentication server in response to receiving the authentication request. The first authentication information, for example, may comprise an ID of a session between the authentication server (101) and the device (102, 201) and/or a random code generated at the authentication server.

Then, the method 400 proceeds to step S403, where the property information and the first authentication information are encoded in an image for transmission to the device (102, 201). The image for example may be implemented as a QR code.

Next in step S404, the decoded first authentication information and second authentication information associated with a user are received from the device (103, 201) for authentication of the user. The second authentication information may comprise a static password received from the user and/or a dynamic password generated in synchronization with the authentication server. In particular, according to embodiments of the present invention, the second authentication information may be generated at a further device (103) different from the device (102) receiving the image; or generated at the same device (201) receiving the image. The authentication server may verify the identity of the user based on the first authentication information and the second authentication information, thereby completing the user authentication process.

In response to successful user authentication, the authentication server may then establish an authorized connection with the device (102, 201) in the optional step S405. In the embodiment as illustrated in FIG. 1, the authentication server may then send a status of the authorized connection to a further device (103) of the user in the optional step S406 and receive a command from the further device to close the authorized connection with the device (102) in the optional step S407.

The method 400 ends after the step S407.

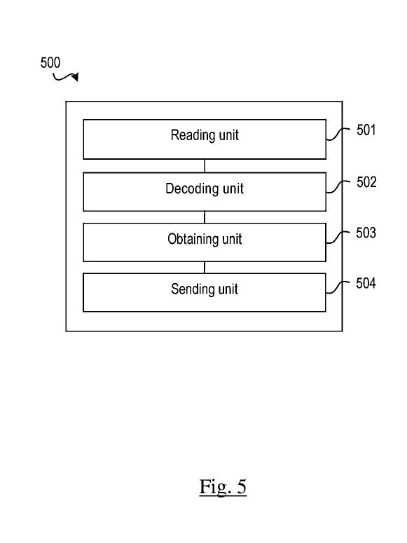

Hereinafter, referring to FIG. 5, it shows a block diagram of an apparatus 500 for user authentication according to embodiments of the present invention. The user authentication apparatus 500 for example may be included in the first device 102 in FIG. 2 or the device 201 in FIG. 2, or associated therewith in other manner.

As shown in the figure, the apparatus 500 for user authentication comprises: a reading unit 501 configured to read an image from a device (102, 201) associated with a user, the image being generated at an authentication server (101) in response to an authentication request received from the device and being sent to the device; a decoding unit 502 configured to decode from the image property information of the device and first authentication information generated at the authentication server; an obtaining unit 503 configured to obtain second authentication information associated with the user; and a sending unit 504 configured to send the first and second authentication information to the authentication server for authentication of the user.

According to some embodiments of the present invention, the first authentication information comprises at least one of: an identifier of a session between the authentication server and the device, and a random code generated at the authentication server.

According to some embodiments of the present invention, the apparatus 500 further comprises: a display control unit configured to cause the decoded property information to be displayed to the user for the user's conformation. At this point, the obtaining unit 503 may be configured to obtain the second authentication information in response to the confirmation of the user.

According to some embodiments of the present invention, the obtaining unit 503 may comprise at least one of: a static password receiving unit configured to receive a static password from the user; and a dynamic password generating unit configured to generate a dynamic password synchronized with the authentication server.

According to some embodiments of the present invention, an authorized connection is established between the authentication server and the device in the case that the user passes the authentication. The apparatus 500 further comprises: a status receiving unit configured to receive information about status of the authorized connection from the authentication server; and a connection control unit configured to instruct the authentication server to close the authorized connection at least partially based on the status.

According to some embodiments of the present invention, the image comprises a QR code.

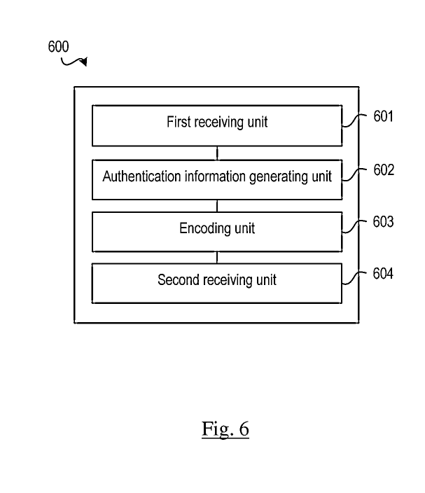

Hereinafter, referring to FIG. 6, it shows a block diagram of an apparatus 600 for user authentication according to embodiments of the present invention. The apparatus 600 for user authentication for example may be included in an authentication server 101 or associated therewith in other manner.

As shown in the figure, the apparatus 600 for user authentication comprises: a first receiving unit 601 configured to receive at an authentication server (101) an authentication request from a device (102, 201) associated with a user, the authentication request at least comprising property information of the device; an authentication information generating unit 602 configured to generate first authentication information for authenticating the user in response to the authentication request; an encoding unit 603 configured to encode the property information and the first authentication information into an image for transmission to the device; and a second receiving unit 604 configured to receive the first authentication information as decoded from the image and second authentication information associated with the user for the authentication.

According to some embodiments of the present invention, the authentication information generating unit 602 comprises at least one of: an identifier obtaining unit configured to obtain an identifier of a session between the authentication server and the device; and a random code generating unit configured to generate a random code for the authentication.

According to some embodiments of the present invention, the second receiving unit 604 comprises: a unit configured to receive, from a further device (103) associated with the user and different from the device (102), the first authentication information decoded at the further device and the second authentication information obtained at the further device.

According to some embodiments of the present invention, the apparatus 600 further comprises: a connection establishing unit configured to establish an authorized connection with the device in response to success of the authentication of the user; a status sending unit configured to send information about status of the authorized connection to the further device; and a connection closing unit configured to close the authorized connection in response to a command from the further device.

According to some embodiments of the present invention, the apparatus 600 further comprises: a dynamic password generating unit configured to generate a dynamic password for comparison with a dynamic password included in the second authentication information.

According to some embodiments of the present invention, the encoding unit 603 comprises: a QR code encoding unit configured to encode the property information and the first authentication information into a QR code.

Please note that for the sake of clarity, FIGS. 5 and 6 do not show any optional units and the sub-units comprised in respective units. However, it should be understood that respective units comprised in apparatuses 500 and 600 correspond to the method steps as above described with reference to FIGS. 3 and 4, respectively. Thus, all features in the above methods are likewise applicable to apparatuses 500 and 600, which will not be detailed here.

It should be understood that the apparatuses 500 and 600 may be implemented in various manners. For example, in some embodiments, the apparatuses 500 and 600 may be implemented using software and/or firmware. For example, the apparatus 500 may be implemented as a computer program executed at the user device (103, 201); the apparatus 600 may be implemented as a computer program executed at the authentication server (101). Alternatively or additionally, the apparatuses 500 and 600 may be partially or completely implemented based on hardware. For example, the apparatuses 500 and 600 may be implemented as an integrated circuit (IC) chip included in the user device (103, 201) and an authentication server (101), an application specific integrated circuit (ASIC), or a system on chip (SOC), respectively. Other currently known or future developed manners are also feasible, and the scope of the present invention is not limited in this aspect.

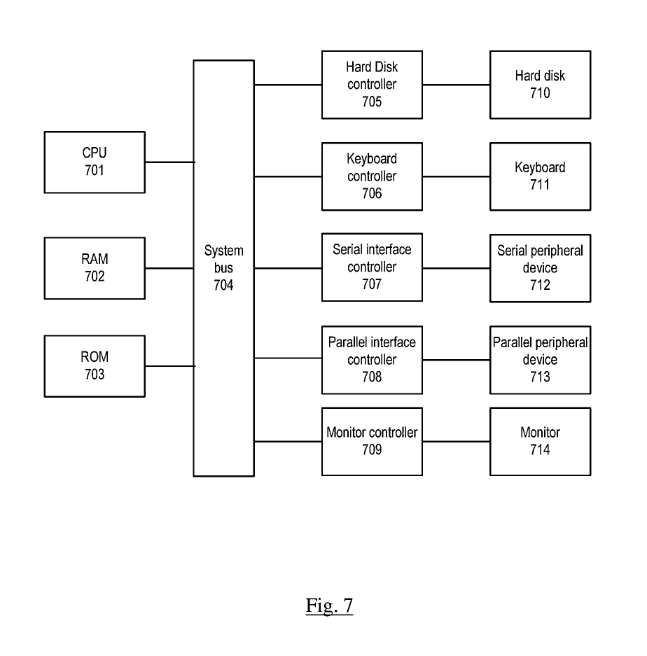

Hereinafter, referring to FIG. 7, it illustrates a block diagram of a system 700 that is applicable to implement embodiments of the present invention. The computer system as shown in FIG. 7 includes a CPU (Central Processing Unit) 701, a RAM (Random Access Memory) 702, a ROM (Read Only Memory) 703, a system bus 704, a hard disk controller 705, a keyboard controller 706, a serial interface controller 707, a parallel interface controller 708, a monitor controller 709, a hard disk 710, a keyboard 711, a serial peripheral device 712, a parallel peripheral device 713 and a monitor 714.Among these components, connected to the system bus 704 are the CPU 701, the RAM 702, the ROM 703, the hard disk controller 705, the keyboard controller 706, the serial interface controller 707, the parallel interface controller 708 and the monitor controller 709. The hard disk 710 is coupled to the hard disk controller 705; the keyboard 711 is coupled to the keyboard controller 706; the serial peripheral device 712 is coupled to the serial interface controller 707; the parallel peripheral device 713 is coupled to the parallel interface controller 708; and the monitor 714 is coupled to the monitor controller 709. It should be understood that the structural block diagram in FIG. 7 is shown only for illustration purpose, and is not intended to limit the scope of the present invention. In some cases, some devices may be added or reduced as required.

As above mentioned, the apparatuses 500 and 600 may be implemented through hardware, for example, chip, ASIC, SOC, etc. Such hardware may be integrated into the computer system 700. Besides, embodiments of the present invention may also be implemented in a form of a computer program product. For example, the methods of the present invention may be unexceptionally implemented through a computer program product. This computer program product may be stored in RAM 704, ROM 704, hard disk 710 and/or any suitable storage medium as illustrated in FIG. 7, or downloaded to the computer system 700 from a suitable location in the network. The computer program product may comprise a computer code portion comprising a program instruction that may be executed through a suitable processing device (for example, CPU 701 in FIG. 7). The program instruction at least may comprise an instruction for implementing the steps of the methods of the present invention.

Embodiments of the present invention can be implemented with software, hardware or the combination thereof. The hardware part can be implemented by a special logic; the software part can be stored in a memory and executed by a proper instruction execution system such as a microprocessor or a design-specific hardware. The normally skilled in the art may understand that the above method and system may be implemented with a computer-executable instruction and/or in a processor controlled code, for example, such code is provided on a bearer medium such as a magnetic disk, CD, or DVD-ROM, or a programmable memory such as a read-only memory (firmware) or a data bearer such as an optical or electronic signal bearer. The system of the present invention may be implemented by hardware circuitry of a programmable hardware device such as a very large scale integrated circuit or gate array, a semiconductor such as logical chip or transistor, or a field-programmable gate array, or a programmable logical device, or implemented by software executed by various kinds of processors, or implemented by combination of the above hardware circuitry and software.

It should be noted that although a plurality of units or subunits of the system have been mentioned in the above detailed depiction, such partitioning is merely non-compulsory. In actuality, according to embodiments of the present invention, the features and functions of the above described two or more units may be embodied in one means. In turn, the features and functions of the above described one means may be further embodied in more units.

Besides, although operations of the present methods are described in a particular order in the drawings, it does not require or imply that these operations must be performed according to this particular sequence, or a desired outcome can only be achieved by performing all shown operations. On the contrary, the execution order for the steps as described in the flowcharts may be varied. Additionally or alternatively, some steps may be omitted, a plurality of steps may be merged into one step, or a step may be divided into a plurality of steps for execution.

Although the present invention has been described with reference to a plurality of embodiments, it should be understood that the present invention is not limited to the disclosed embodiments. On the contrary, the present invention intends to cover various modifications and equivalent arrangements included in the spirit and scope of the appended claims. The scope of the claims covers all such modifications and equivalent structures and functions.

What is claimed is:

1. A method for user authentication, comprising:
reading an image from a device associated with a user, the image being generated at an authentication server in response to an authentication request received from the device and being sent to the device;
decoding, from the image, property information of the device and first authentication information generated at the authentication server;
obtaining second authentication information associated with the user; and
sending the first and second authentication information to the authentication server for authentication of the user.

2. The method according to claim 1, wherein the first authentication information comprises at least one of: an identifier of a session between the authentication server and the device, and a random code generated at the authentication server.

3. The method according to claim 1, further comprising:
causing the decoded property information to be displayed to the user for confirmation of the user,
wherein the second authentication information is obtained in response to the conformation of the user.

4. The method according to claim 1, wherein obtaining the second authentication information comprises at least one of:
receiving a static password from the user; and
generating a dynamic password synchronized with the authentication server.

5. The method according to claim 1, wherein an authorized connection is established between the authentication server and the device if the user passes the authentication, the method further comprising:
receiving information about status of the authorized connection from the authentication server; and
instructing the authentication server to close the authorized connection at least partially based on the status.

6. The method according to any of claim 1, wherein the image comprises a QR code.

7. A method for user authentication, comprising:
receiving, at an authentication server, an authentication request from a device associated with a user, the authentication request at least comprising property information of the device;
generating first authentication information in response to the authentication request, the first authentication information being for use in authentication of the user;
encoding the property information and the first authentication information into an image for transmission to the device; and
receiving the first authentication information decoded from the image and second authentication information associated with the user for the authentication.

8. The method according to claim 7, wherein the first authentication information comprises at least one of:
an identifier of a session between the authentication server and the device; and
a random code for the authentication.

9. The method according to claim 7, wherein receiving the first authentication information decoded from the image and second authentication information comprises:
receiving, from a further device associated with the user and different from the device, the first authentication information decoded at the further device and the second authentication information obtained at the further device.

10. The method according to claim 9, further comprising:
establishing an authorized connection with the device in response to success of the authentication of the user;
sending information about status of the authorized connection to the further device; and
closing the authorized connection in response to a command from the further device.

11. The method according to claim 7, further comprising:
generating a dynamic password for comparison with a dynamic password contained in the second authorization information.

12. The method according to any of claim 7, wherein generating the image comprises:
encoding the property information and the first authentication information into a QR code.

13. An apparatus for user authentication, comprising:
a reading unit configured to read an image from a device associated with a user, the image being generated at an authentication server in response to an authentication request received from the device and being sent to the device;
a decoding unit configured to decode, from the image, property information of the device and first authentication information generated at the authentication server;
an obtaining unit configured to obtain second authentication information associated with the user; and
a sending unit configured to send the first and second authentication information to the authentication server for authentication of the user.

14. The apparatus according to claim 13, wherein the first authentication information comprises at least one of: an identifier of a session between the authentication server and the device, and a random code generated at the authentication server.

15. The apparatus according to claim 13, further comprising:
a display control unit configured to cause the decoded property information to be displayed to the user for confirmation of the user,
wherein obtaining unit is configured to obtain the second authentication information in response to the conformation of the user.

16. The apparatus according to claim 13, wherein the obtaining unit comprises at least one of:
a static password receiving unit configured to receive a static password from the user; and
a dynamic password generating unit configured to generate a dynamic password synchronized with the authentication server.

17. The apparatus according to claim 13, wherein an authorized connection is established between the authentication server and the device if the user passes the authentication, the apparatus further comprising:
a status receiving unit configured to receive information about status of the authorized connection from the authentication server; and
a connection control unit configured to instruct the authentication server to close the authorized connection at least partially based on the status.

18. The apparatus according to any of claim 13, wherein the image comprises a QR code.
